(19) United States
(12) Patent Application Publication
(10) Pub. No.: US 2018/0218415 A1
(43) Pub. Date: Aug. 2, 2018

(54) DATA CENTER AND INFORMATION PROCESSING DEVICE

(71) Applicant: FUJITSU LIMITED, Kawasaki-shi (JP)

(72) Inventors: Kohei Nakahara, Yokohama (JP); Kota Iriguchi, Kawasaki (JP); Isao Higashi, Yokohama (JP)

(73) Assignee: FUJITSU LIMITED, Kawasaki-shi (JP)

(21) Appl. No.: 15/879,314

(22) Filed: Jan. 24, 2018

(30) Foreign Application Priority Data
Jan. 30, 2017 (JP) 2017-014075

(51) Int. Cl. G06Q 30/02; H04L 12/14; G06F 9/455

(52) U.S. Cl. CPC G06Q 30/0283; G06F 2009/45595; G06F 9/45558; H04L 12/1421

(57) ABSTRACT

A data center includes a server, which hosts a plurality of virtual machines, and an information processing device. The information processing device is configured to receive from a user terminal device, which is communicatively connected to the data center, a usage request for the use of a service executed by one of the plurality of virtual servers for a finite period of time. The finite period of time occurs within a first time period. The information processing device is configured to calculate a cumulative usage fee for the usage request based on the finite period of time included in the usage request, a previous usage duration time of the service by the user terminal device, and a usage fee per unit time associated with the previous usage duration time. The information processing device is configured to output the predicted cumulative usage fee.

### CROSS-REFERENCE TO RELATED APPLICATION

This application is based upon and claims the benefit of priority of the prior Japanese Patent Application No. 2017-014075, filed on Jan. 30, 2017, the entire contents of which are incorporated herein by reference.

### FIELD

The embodiment discussed herein is related to a data center and an information processing device.

### BACKGROUND

In recent years, with improvements in performance of physical machines, research into a virtualization technology has been underway, the virtualization technology integrating a plurality of virtual machines into one physical machine. In this virtualization technology, for example, virtualization software enables each virtual machine to provide service, by allocating physical resources of the physical machine to the plurality of virtual machines.

For example, an operator providing service to users (which operator will hereinafter be referred to also as a cloud user) rents a desired virtual machine from an operator renting out virtual machines (which operator will hereinafter be referred to also as a cloud operator), and constructs a business system for providing the service to the users. The cloud user may thereby construct a business system without the purchase of a desired physical machine or the like.

Related techniques are disclosed in, for example, Japanese Laid-open Patent Publication No. 2002-312699, Japanese Laid-open Patent Publication No. 11-143930, and Japanese Laid-open Patent Publication No. 09-229336.

When renting a virtual machine as described above, the cloud user, for example, determines an upper limit value of a usage fee of the virtual machine in advance. The cloud operator may therefore determine whether or not to rent out the virtual machine according to whether or not a usage fee (predicted value of a cumulative usage fee) corresponding to a usage scheduled time of the virtual machine, for which an application is made by the cloud user, exceeds the upper limit value.

However, the usage scheduled time of the virtual machine for which the application is made by the cloud user may greatly differ from a time of actual use of the virtual machine by the cloud user (which time will hereinafter be referred to also as a usage actual result time). Therefore, the cloud operator may not be able to predict the usage fee with high accuracy, and may not be able to properly determine whether or not to rent out the virtual machine.

### SUMMARY

According to an aspect of the present invention, provided is a data center including a server hosting a plurality of virtual machines and an information processing device. The information processing device is configured to receive from a user terminal device, which is communicatively connected to the data center, a usage request for the use of a service executed by one of the plurality of virtual servers for a finite period of time. The finite period of time occurs within a first time period. The information processing device is configured to obtain from a memory, in response to the usage request, data indicating previous usage duration time of the service by the user terminal device and a usage fee per unit time associated with the previous usage duration time. The information processing device is configured to calculate a cumulative usage fee for the usage request based on the finite period of time included in the usage request, the previous usage duration time of the service by the user terminal device, and the usage fee per unit time associated with the previous usage duration time. The information processing device is configured to output the predicted cumulative usage fee.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an entire configuration of an information processing system;

FIG. 2 is a diagram of assistance in explaining renting of a virtual machine by a cloud user;

FIG. 3 is a diagram of assistance in explaining renting of a virtual machine by a cloud user;

FIG. 4 is a diagram of assistance in explaining a hardware configuration of an information processing device;

FIG. 5 is a functional block diagram of an information processing device;

FIG. 6 is a flowchart of assistance in explaining an outline of usage fee prediction processing in a first embodiment;

FIG. 7 is a diagram of assistance in explaining an outline of usage fee prediction processing in the first embodiment;

FIG. 8 is a diagram of assistance in explaining an outline of usage fee prediction processing in the first embodiment;

FIG. 9 is a flowchart of assistance in explaining details of usage fee prediction processing in the first embodiment;

FIG. 10 is a flowchart of assistance in explaining details of usage fee prediction processing in the first embodiment;

FIG. 11 is a flowchart of assistance in explaining details of usage fee prediction processing in the first embodiment;

FIG. 12 is a flowchart of assistance in explaining details of usage fee prediction processing in the first embodiment;

FIG. 13 is a flowchart of assistance in explaining details of usage fee prediction processing in the first embodiment;

FIG. 14 is a flowchart of assistance in explaining details of usage fee prediction processing in the first embodiment;

FIG. 15 is a flowchart of assistance in explaining details of usage fee prediction processing in the first embodiment;

FIG. 16 is a flowchart of assistance in explaining details of usage fee prediction processing in the first embodiment;

FIG. 17 is a flowchart of assistance in explaining details of usage fee prediction processing in the first embodiment;

FIG. 18 is a flowchart of assistance in explaining details of usage fee prediction processing in the first embodiment;

FIG. 19 is a flowchart of assistance in explaining details of usage fee prediction processing in the first embodiment;

FIG. 20 is a flowchart of assistance in explaining details of usage fee prediction processing in the first embodiment;

FIG. 21 is a flowchart of assistance in explaining details of usage fee prediction processing in the first embodiment;

FIG. 22 is a diagram of assistance in explaining a concrete example of usage actual result information;

FIG. 23 is a diagram of assistance in explaining a concrete example of usage schedule information;

FIG. 24 is a diagram of assistance in explaining a concrete example of usage fee information;

FIG. 25 is a diagram of assistance in explaining a concrete example of weighting information;

FIG. 26 is a diagram of assistance in explaining details of usage fee prediction processing in the first embodiment; and

FIG. 27 is a diagram of assistance in explaining a concrete example of usage schedule information.

### DESCRIPTION OF EMBODIMENT

Configuration of Information Processing System

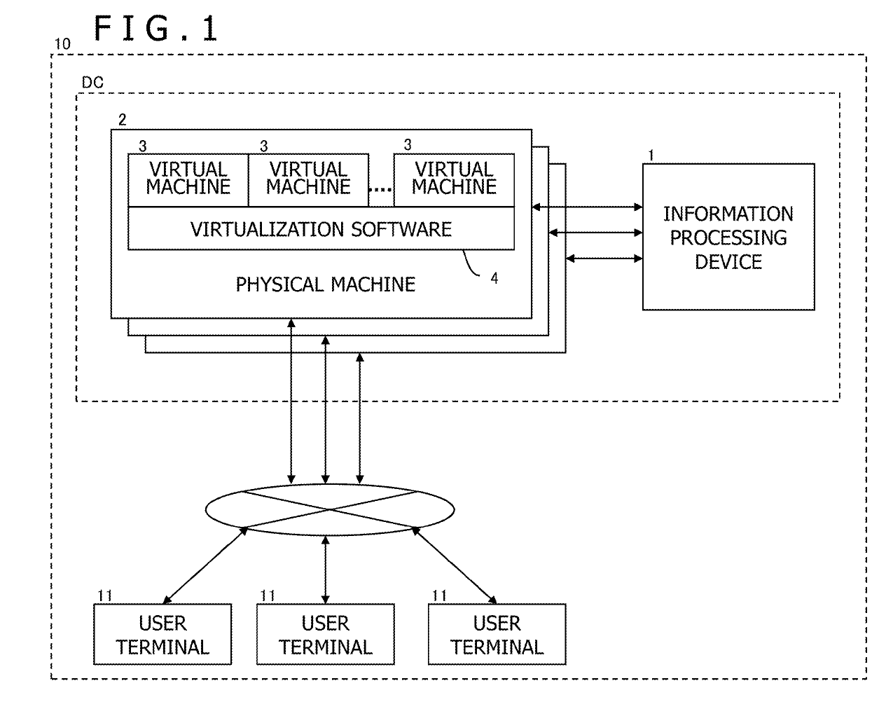

FIG. 1 is a diagram illustrating an entire configuration of an information processing system. An information processing system 10 illustrated in FIG. 1 is, for example, a business system for providing service to users. In the information processing system 10 illustrated in FIG. 1, an information processing device 1 and a physical machine 2 are provided within a data center DC. User terminals 11 may access the data center DC via a network such as the Internet or an intranet.

The physical machine 2 is, for example, constituted of a plurality of physical machines. Each of the physical machines includes a central processing unit (CPU), a memory (dynamic random access memory (DRAM)), and a high-capacity memory such as a hard disk (hard disk drive (HDD)). Physical resources of the physical machine 2 are assigned to a plurality of virtual machines 3.

The information processing device 1 may access the virtual machines 3, and manages the virtual machines 3 created in the physical machine 2. The information processing device 1 may, for example, be created by a virtual machine 3.

The virtual machines 3 provide an infrastructure thereof to cloud users via the network (the provision of the infrastructure will hereinafter be referred to also as cloud service).

The cloud service is a service providing, via the network, a foundation for constructing and operating a computer system, for example, an infrastructure such as the virtual machines 3 or networks. In addition, for example, cloud users select, via the user terminals 11, specifications desired in the virtual machines 3, for example, the clock frequency of a CPU, the capacity of a memory, the capacity of a hard disk, and the communication bandwidth of a network, and conclude a cloud usage contract therefor. Further, the cloud users may, for example, perform monitoring of the operational states of the virtual machines 3, operation of the virtual machines 3, and the like via the user terminals 11.

Virtualization software 4 is infrastructure software that operates the virtual machines 3 by allocating the CPUs, memories, hard disks, and networks of the physical machine 2 according to an instruction from the information processing device 1. The virtualization software 4, for example, operates on the physical machine 2.

Renting of Virtual Machine by Cloud User

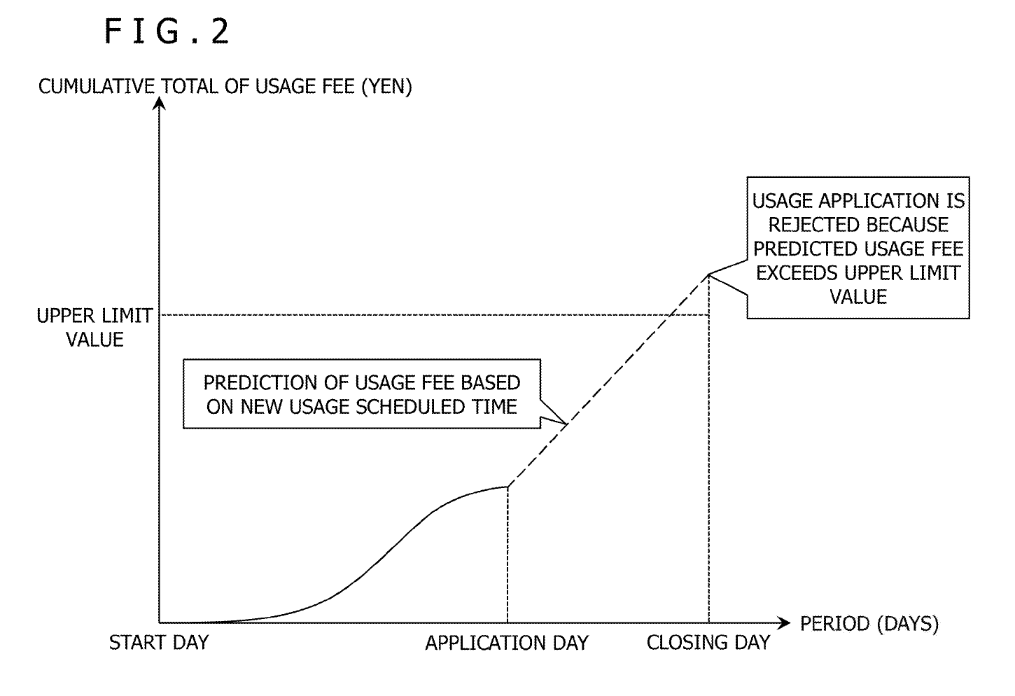

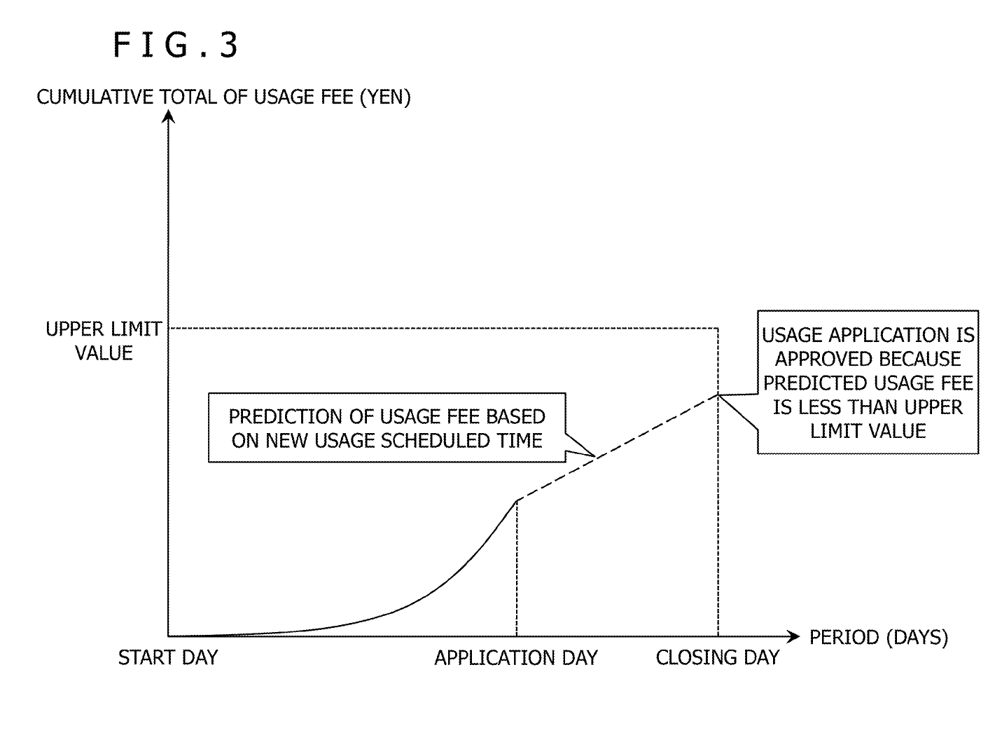

Description will next be made of renting of a virtual machine by a cloud user. FIG. 2 and FIG. 3 are diagrams of assistance in explaining renting of a virtual machine by a cloud user. The virtual machine described with reference to FIG. 2 and FIG. 3 may be the virtual machine 3 depicted in FIG. 1.

When a cloud user providing service to users, for example, constructs a business system for providing the service, the cloud user rents a desired virtual machine 3 from a cloud operator renting out the virtual machine.

Here, when the cloud user rents the virtual machine 3, the cloud user, for example, determines in advance an upper limit value of a usage fee for the virtual machine 3. The cloud operator may thereby determine whether or not to rent out the virtual machine 3 according to whether or not the usage fee corresponding to a usage scheduled time of the virtual machine 3 for which an application is made by the cloud user (predicted value of a cumulative usage fee) exceeds the upper limit value.

It is assumed that the cloud user rents the virtual machine 3 for a period from a start day to a closing day. The cloud user may make an application for using the virtual machine 3 on an arbitrary day during the period. For example, when the cloud user makes an application for using the virtual machine 3 on a certain day (application day in the figures), the information processing device 1 predicts a cumulative usage fee of the virtual machine 3 on the closing day. As illustrated in FIG. 2, when it is determined that the predicted value of the cumulative usage fee of the virtual machine 3 on the closing day exceeds the upper limit value, the cloud operator determines that the virtual machine 3 is not to be rented out (that the application for using the virtual machine 3 by the cloud user is to be rejected). On the other hand, as illustrated in FIG. 3, when it is determined that the predicted value of the cumulative usage fee of the virtual machine 3 on the closing day is less than the upper limit value, for example, the cloud operator determines that the virtual machine 3 is to be rented out (that the application for using the virtual machine 3 by the cloud user is approved).

However, the usage scheduled time of the virtual machine 3 for which the application is made by the cloud user may greatly differ from a usage actual result time of the cloud user. Therefore, the cloud operator may not be able to predict the usage fee with high accuracy, and may not be able to determine properly whether or not to rent out the virtual machine 3.

Accordingly, in response to receiving the usage scheduled time, which is a scheduled time of use of the virtual machine 3 within a particular period (hereinafter referred to also as a first period), the information processing device 1 obtains, from a storage unit, a past usage actual result time of actual use of the virtual machine 3 and a usage fee per unit time which usage fee occurs with the use of the virtual machine 3. The information processing device 1 then predicts a cumulative usage fee occurring up to a given time point with the use of the virtual machine 3 based on the usage scheduled time, the usage actual result time, and the usage fee per unit time. The information processing device 1 thereafter outputs the predicted cumulative usage fee.

For example, the information processing device 1 in the present embodiment predicts the cumulative usage fee of the virtual machine 3 at a time point in the future in consideration of usage actual result information, which is information indicating conditions of past use of the virtual machine 3 by the cloud user, in addition to the usage scheduled time for which an application is made when the cloud user rents the virtual machine 3.

The information processing device 1 may thereby predict the cumulative usage fee of the virtual machine 3 at a time point in the future with higher accuracy. The information processing device 1 may therefore determine whether or not to rent out the virtual machine 3 with high accuracy.

Hardware Configuration of Information Processing Device

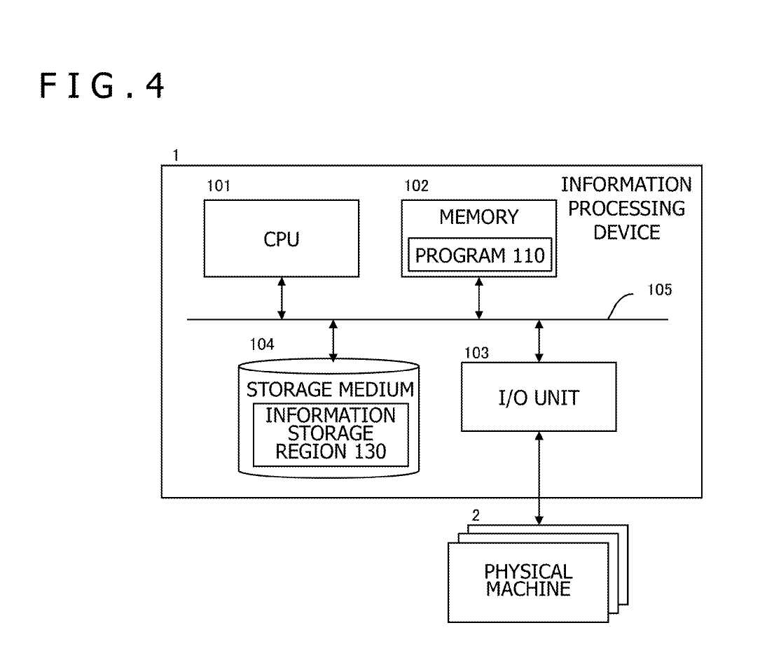

A hardware configuration of an information processing device will next be described. FIG. 4 is a diagram of assistance in explaining a hardware configuration of an information processing device. The information processing device depicted in FIG. 4 may be the information processing device 1 depicted in FIG. 1.

The information processing device 1 includes a CPU 101 as a processor, a memory 102, an external interface (input/output (I/O) unit) 103, and a storage medium (storage) 104. The parts are coupled to each other via a bus 105.

The storage medium 104 stores a program 110 for performing processing of predicting a usage fee (which processing will hereinafter be referred to also as usage fee prediction processing) in a program storage region (not illustrated) within the storage medium 104.

As illustrated in FIG. 4, at a time of execution of the program 110, the CPU 101 loads the program 110 from the storage medium 104 into the memory 102, and performs the usage fee prediction processing in cooperation with the program 110.

The storage medium 104, for example, includes an information storage region 130 (hereinafter referred to also as a storage unit 130) that stores information used when the usage fee prediction processing is performed. In addition, the external interface 103 performs communication with the physical machine 2.

Software Configuration of Information Processing Device

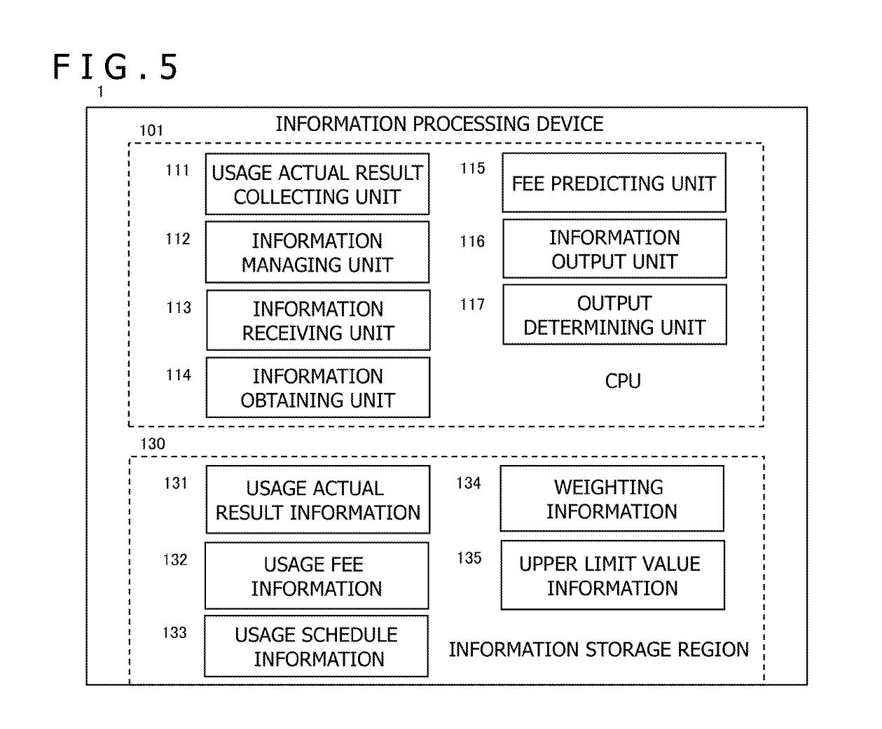

A software configuration of an information processing device will next be described. FIG. 5 is a functional block diagram of an information processing device. The information processing device depicted in FIG. 5 may be the information processing device 1 depicted in FIG. 1. As illustrated in FIG. 5, by cooperating with the program 110, the CPU 101 operates as a usage actual result collecting unit 111, an information managing unit 112, an information receiving unit 113, an information obtaining unit 114, a fee predicting unit 115, an information output unit 116, and an output determining unit 117.

In addition, as illustrated in FIG. 5, the information storage region 130 stores usage actual result information 131, usage fee information 132, usage schedule information 133, weighting information 134, and upper limit value information 135.

The usage actual result collecting unit 111 collects a time for which a cloud user actually uses a virtual machine 3 (usage actual result time). For example, the usage actual result collecting unit 111 obtains usage actual result information 131 including the usage actual result time of the virtual machine 3 in periodic timing (for example, once a day). The information managing unit 112 then stores the usage actual result information 131 obtained by the usage actual result collecting unit 111 in the information storage region 130.

The information receiving unit 113 receives usage schedule information 133 (application for using the virtual machine 3) transmitted by the cloud user via the user terminal 11. The usage schedule information 133, for example, includes information indicating the usage scheduled time of the virtual machine 3 which usage scheduled time is desired by the cloud user and the virtual machine 3 that the cloud user desires to rent. The information managing unit 112 then stores the usage schedule information 133 received by the information receiving unit 113 in the information storage region 130.

The information obtaining unit 114 obtains the usage actual result information 131, the usage fee information 132, and the usage schedule information 133 stored in the information storage region 130. The usage fee information 132 is information indicating a usage fee that the cloud operator charges the cloud user using the virtual machine 3. For example, the usage fee information 132 is information indicating a usage fee per unit time of the virtual machine 3. Incidentally, for example, the cloud operator may store the usage fee information 132 in the information storage region 130 in advance.

The fee predicting unit 115 predicts a cumulative usage fee occurring up to a given time point (for example, a time point of an end of the first period) with the use of the virtual machine based on the usage scheduled time included in the usage schedule information 133, the usage actual result time included in the usage actual result information 131, and the usage fee per unit time which usage fee is indicated by the usage fee information 132.

The information output unit 116 outputs the predicted value of the cumulative usage fee predicted by the fee predicting unit 115 to the user terminal 11.

The output determining unit 117 determines whether or not the predicted value output by the fee predicting unit 115 exceeds an upper limit value. For example, the output determining unit 117 refers to the upper limit value information 135, which is information indicating the upper limit value of the usage fee of the virtual machine 3, and determines whether or not the predicted value exceeds the upper limit value. Then, when determining that the predicted value exceeds the upper limit value, the output determining unit 117, for example, outputs, to the user terminal 11, information indicating that the application for using the virtual machine 3 which application is received by the information receiving unit 113 is rejected.

Incidentally, the weighting information 134 in the information stored in the information storage region 130 will be described later.

### Outline of First Embodiment

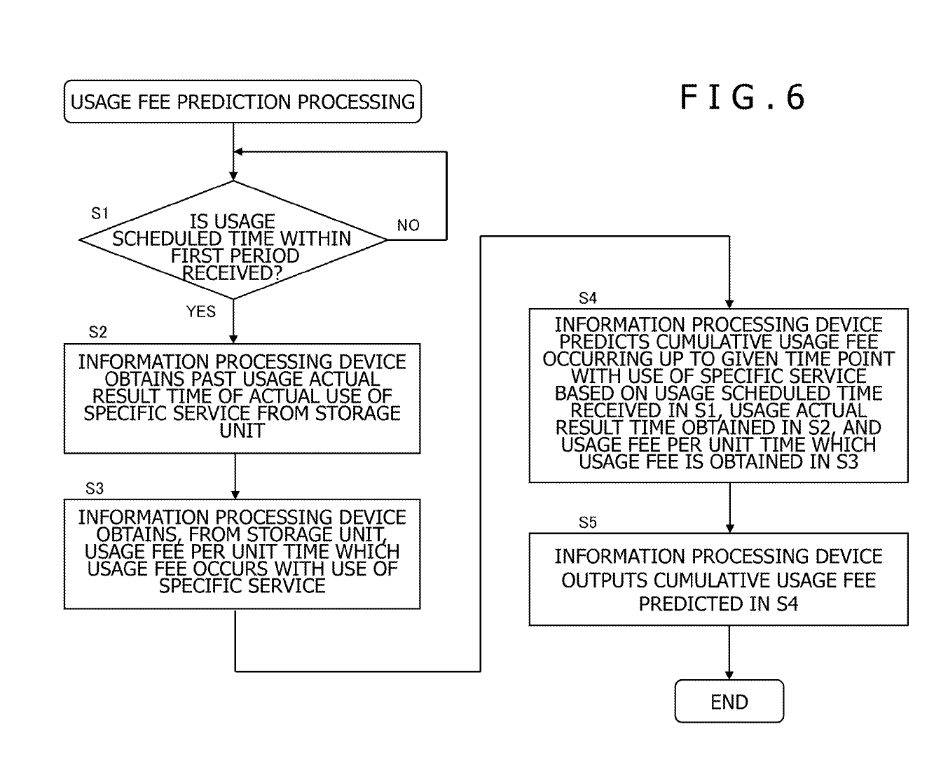

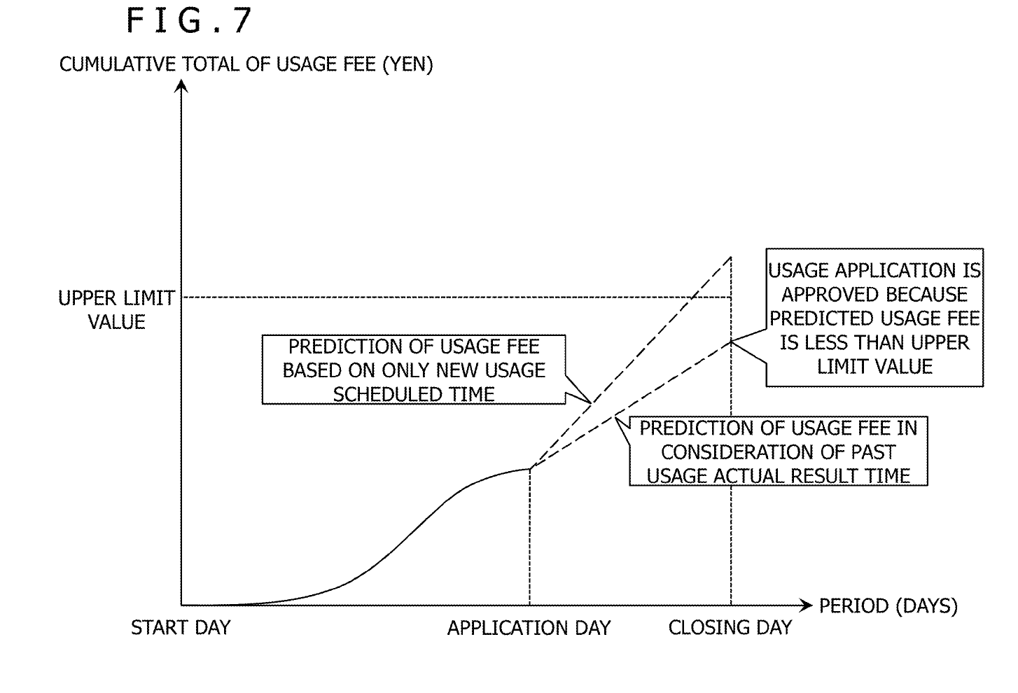

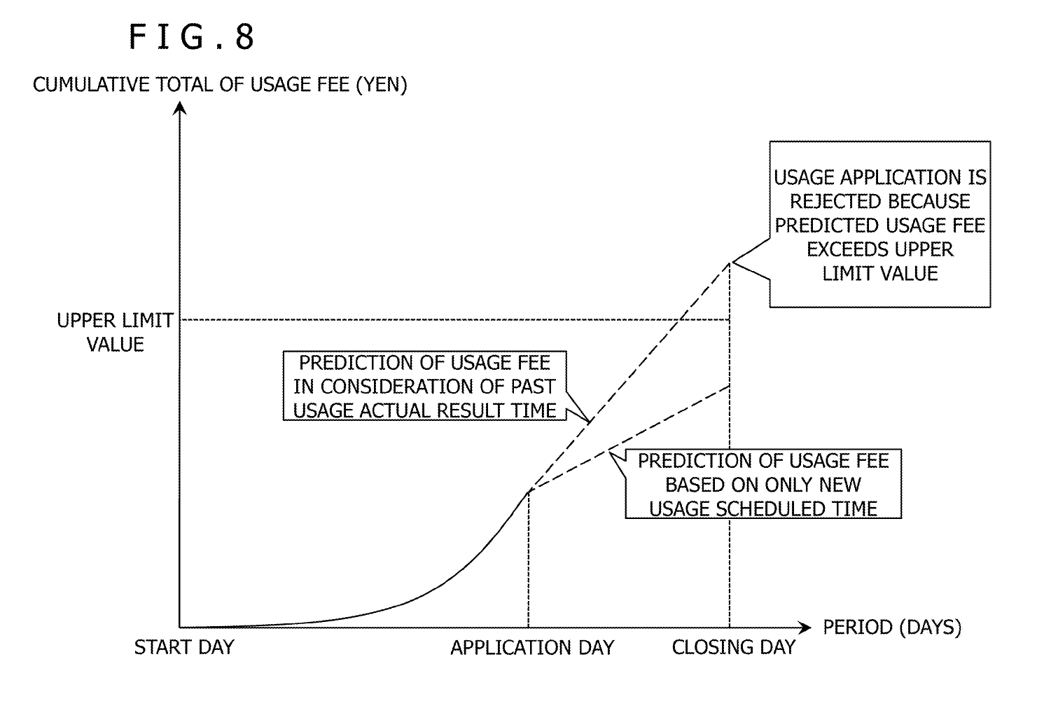

An outline of a first embodiment will next be described. FIG. 6 is a flowchart of assistance in explaining an outline of usage fee prediction processing in the first embodiment. FIG. 7 and FIG. 8 are diagrams of assistance in explaining an outline of usage fee prediction processing in the first embodiment. The usage fee prediction processing illustrated in FIG. 6 will be described while reference is made to FIG. 7 and FIG. 8.

As illustrated in FIG. 6, the information processing device 1 waits until receiving a usage scheduled time within the first period (NO in S1). For example, the information processing device 1 waits until receiving a usage scheduled time transmitted by the cloud user via the user terminal 11.

Then, when receiving the usage scheduled time (YES in S1), the information processing device 1 obtains a past usage actual result time of actual use of specific service from the information storage region 130 (S2). In addition, in this case, the information processing device 1 obtains, from the information storage region 130, a usage fee per unit time which usage fee occurs with the use of the specific service (S3).

The information processing device 1 thereafter predicts a cumulative usage fee occurring up to a given time point with the use of the specific service based on the usage scheduled time received in the processing of S1, the usage actual result time obtained in the processing of S2, and the usage fee per unit time which usage fee is obtained in the processing of S3 (S4). Further, the information processing device 1 outputs the cumulative usage fee predicted in the processing of S4 (S5).

For example, the information processing device 1 in the present embodiment predicts the cumulative usage fee of the virtual machine 3 at a time point in the future in consideration of usage actual result information, which is information indicating conditions of past use of the virtual machine 3 by the cloud user, in addition to the usage scheduled time for which an application is made when the cloud user rents the virtual machine 3.

For example, as illustrated in FIG. 7, even in a case where the predicted value of the cumulative usage fee on a closing day which predicted value is calculated from only the usage scheduled time exceeds the upper limit value, when the predicted value of the cumulative usage fee on the closing day which predicted value is calculated from the usage scheduled time and the usage actual result time is less than the upper limit value, the information processing device 1 determines that the virtual machine 3 is to be rented out. On the other hand, as illustrated in FIG. 8, even in a case where the predicted value of the usage fee on the closing day which predicted value is calculated from only the usage scheduled time is less than the upper limit value, for example, when the predicted value of the usage fee on the closing day which predicted value is calculated from the usage scheduled time and the usage actual result time exceeds the upper limit value, the information processing device 1 determines that the virtual machine 3 is not to be rented out.

The information processing device 1 may thereby predict the cumulative usage fee of the virtual machine 3 at a time point in the future with higher accuracy. The information processing device 1 may therefore determine whether or not to rent out the virtual machine 3 with high accuracy.

### Details of First Embodiment

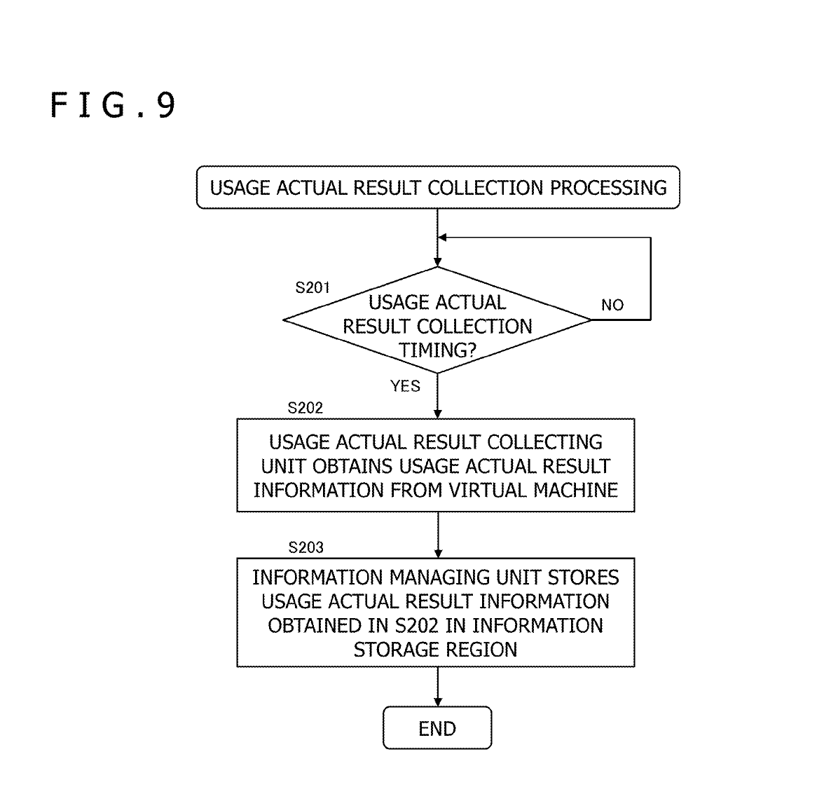

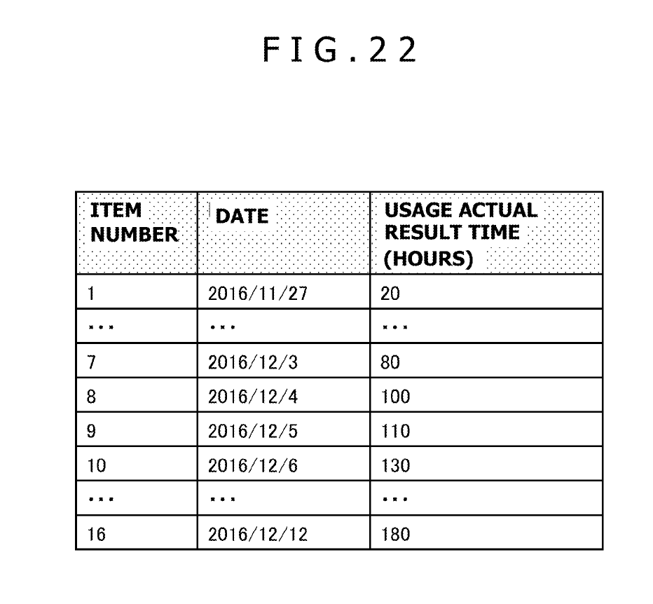

Details of the first embodiment will next be described. FIGS. 9 to 21 are flowcharts of assistance in explaining details of usage fee prediction processing in the first embodiment. In addition, FIGS. 22 to 27 are diagrams of assistance in explaining details of usage fee prediction processing in the first embodiment. The usage fee prediction processing illustrated in FIGS. 9 to 21 will be described while reference is made to FIGS. 22 to 27.

Usage Actual Result Collection Processing

Description will first be made of processing of collecting the usage actual result information 131 (which processing will hereinafter be referred to also as usage actual result collection processing). FIG. 9 is a diagram of assistance in explaining the usage actual result collection processing.

As illustrated in FIG. 9, the usage actual result collecting unit 111 of the information processing device 1 waits until usage actual result collection timing (NO in S201). The usage actual result collection timing is, for example, periodic timing (for example, once a day).

Then, when the usage actual result collection timing arrives (YES in S201), the usage actual result collecting unit 111 obtains the usage actual result information 131 including a usage actual result time from the virtual machine 3 providing service to users (S202). The information managing unit 112 of the information processing device 1 thereafter stores the usage actual result information 131 obtained in the processing of S202 in the information storage region 130 (S203). The following description will be made of a concrete example of the usage actual result information 131 stored in the information storage region 130.

Concrete Example of Usage Actual Result Information

FIG. 22 is a diagram of assistance in explaining a concrete example of the usage actual result information 131. The usage actual result information 131 illustrated in FIG. 22 includes, as items, an “item number” identifying each piece of information included in the usage actual result information 131 and a “date” indicating a date of obtainment of each piece of information in the usage actual result information 131. The usage actual result information 131 illustrated in FIG. 22 also includes, as an item, a “usage actual result time,” in which a usage actual result time obtained on the date set as the “date” (cumulative total of usage actual result times up to the date set as the “date”) is set. Incidentally, the usage actual result information 131 illustrated in FIG. 22 is information generated for each cloud user.

For example, in the usage actual result information 131 illustrated in FIG. 22, information having “1” as an “item number” has “2016/11/27” set therein as a “date,” and has “20 (hours)” set therein as a “usage actual result time.” In addition, in the usage actual result information 131 illustrated in FIG. 22, information having “8” as an “item number” has “2016/12/4” set therein as a “date,” and has “100 (hours)” set therein as a “usage actual result time.”

For example, the usage actual result information 131 illustrated in FIG. 22 indicates that a cumulative total of usage actual result times in a period from Nov. 27, 2016 to Dec. 4, 2016 is 100 (hours). Description of other information included in FIG. 22 will be omitted.

Usage Fee Prediction Processing (1)

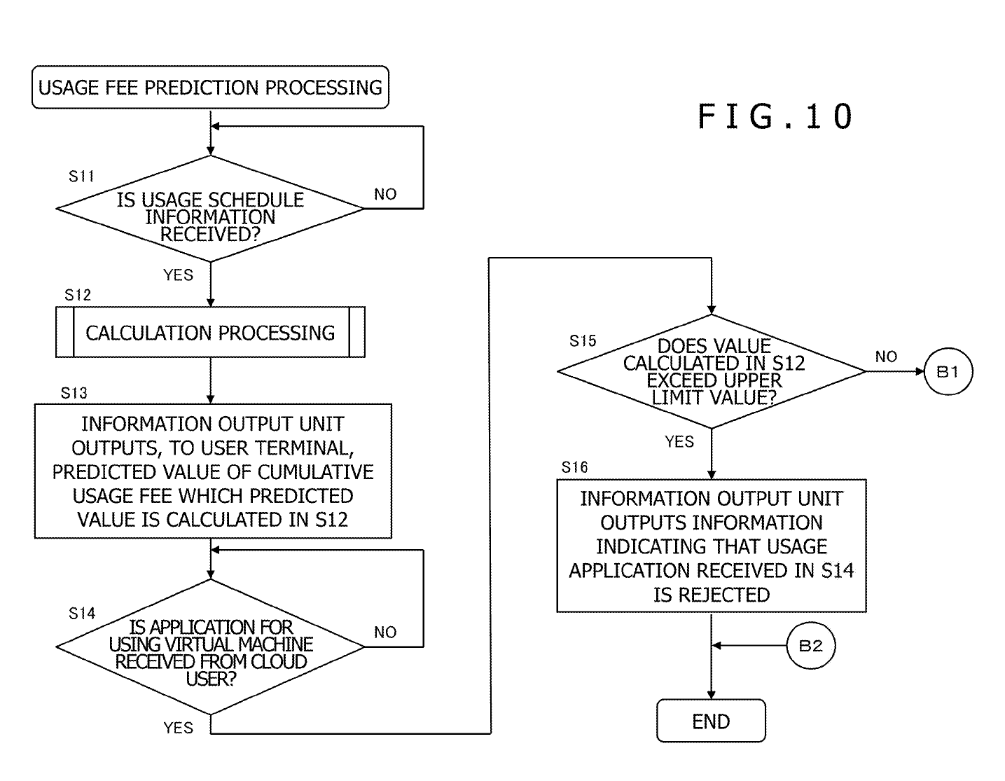

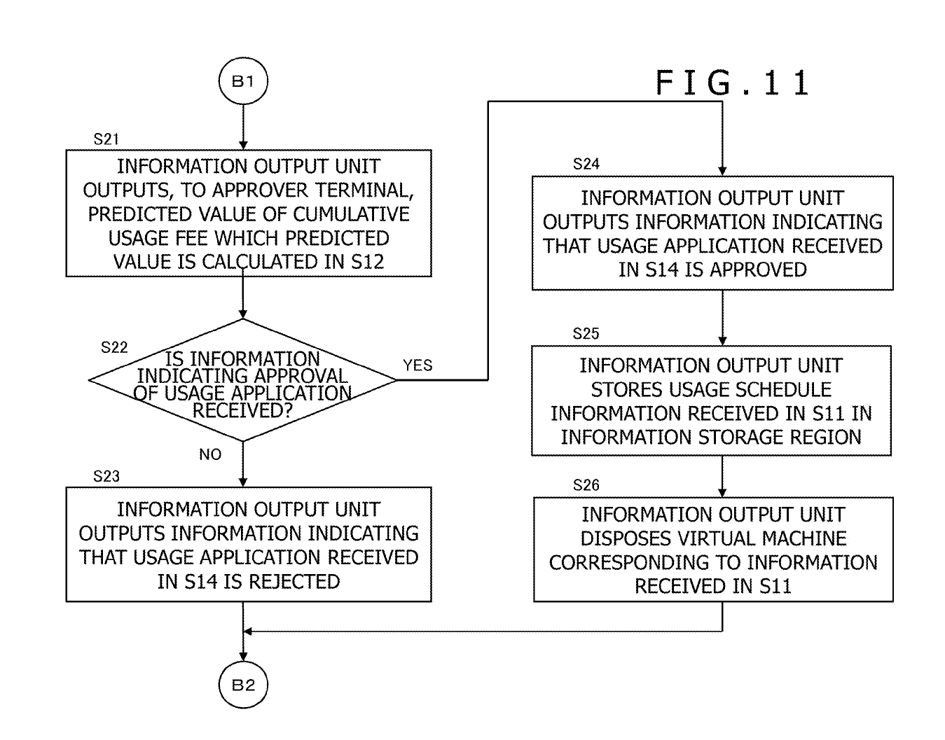

Description will next be made of usage fee prediction processing performed when a new application for using the virtual machine 3 is received in a case where the cloud user is already using the virtual machine 3. FIG. 10 and FIG. 11 are diagrams of assistance in explaining the usage fee prediction processing performed when a new application for using the virtual machine 3 is received.

As illustrated in FIG. 10, the information receiving unit 113 of the information processing device 1 waits until receiving the usage schedule information 133 transmitted by the cloud user via the user terminal 11 (NO in S11).

When the information receiving unit 113 then receives the usage schedule information 133 (YES in S11), the information obtaining unit 114 and the like of the information processing device 1 perform calculation processing (S12). The calculation processing will be described in the following.

Calculation Processing (1)

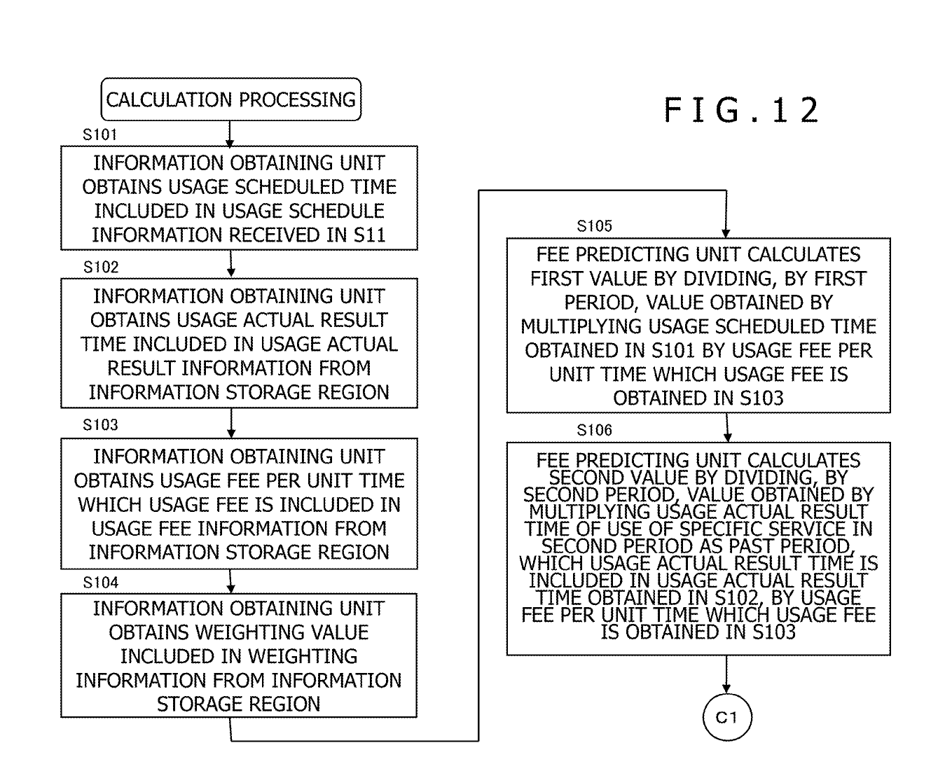

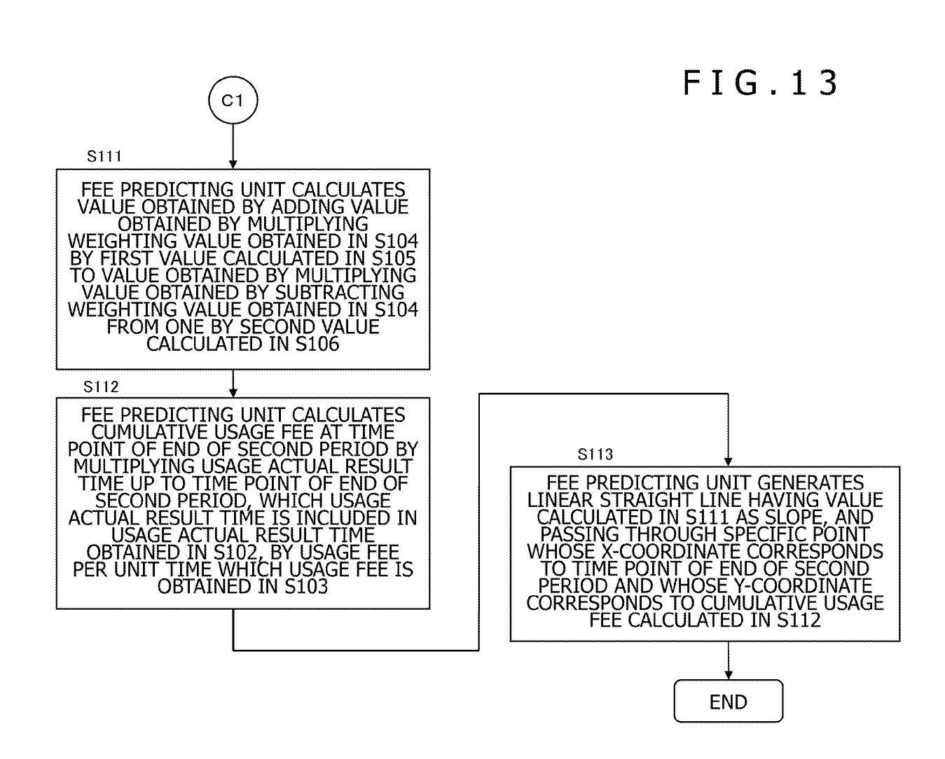

FIG. 12 and FIG. 13 are diagrams of assistance in explaining the calculation processing. For example, FIG. 12 and FIG. 13 are diagrams of assistance in explaining the calculation processing performed when the usage schedule information 133 is received from the cloud user, for example.

When the information receiving unit 113 receives the usage schedule information 133 (YES in S11), for example, the information obtaining unit 114 obtains the usage scheduled time included in the received usage schedule information 133 (S101). A concrete example of the usage schedule information 133 will be described in the following.

Concrete Example of Usage Schedule Information

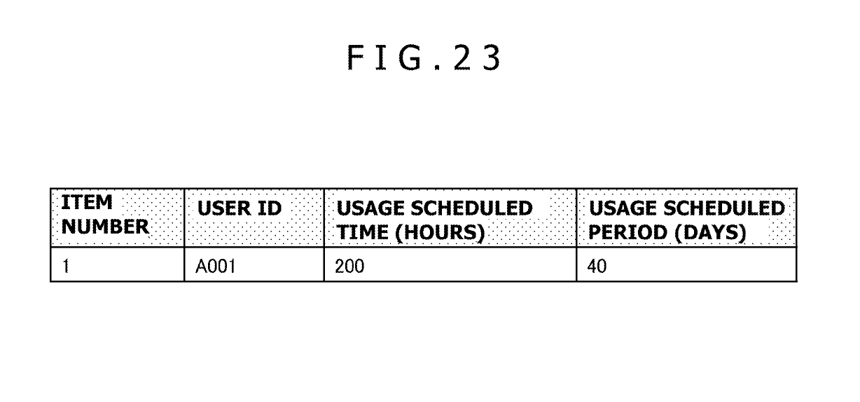

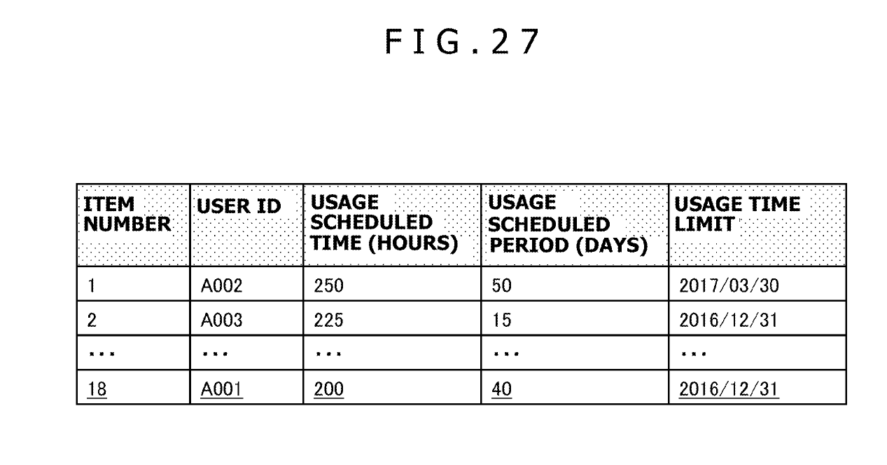

FIG. 23 and FIG. 27 are diagrams of assistance in explaining a concrete example of the usage schedule information 133. The usage schedule information 133 illustrated in FIG. 23 and FIG. 27 includes, as items, an “item number” identifying each piece of information included in the usage schedule information 133 and a “user ID” identifying a cloud user making an application for using a virtual machine 3. In addition, the usage schedule information 133 illustrated in FIG. 23 and FIG. 27 includes, as items, a “usage scheduled time” indicating the usage scheduled time of the virtual machine 3 and a “usage scheduled period” indicating a period (number of days) of use of the virtual machine 3.

For example, in the usage schedule information 133 illustrated in FIG. 23, information having “1” as an “item number” has “A001” set therein as a “user ID,” and has “200 (hours)” set therein as a “usage scheduled time.” In addition, in the usage schedule information 133 illustrated in FIG. 23, the information having “1” as the “item number” has “40 (days)” set therein as a “usage scheduled period.”

Returning to FIG. 12, when the information receiving unit 113 receives the usage schedule information 133 (YES in S11), for example, the information obtaining unit 114 further obtains the usage actual result time included in the usage actual result information 131 from the information storage region 130 (S102). In addition, in this case, the information obtaining unit 114 obtains the usage fee per unit time which usage fee is included in the usage fee information 132 from the information storage region 130 (S103). A concrete example of the usage fee information 132 will be described in the following.

Concrete Example of Usage Fee Information

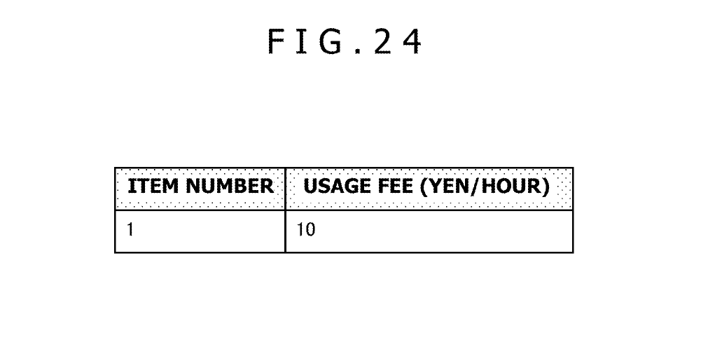

FIG. 24 is a diagram of assistance in explaining a concrete example of the usage fee information 132. The usage fee information 132 illustrated in FIG. 24 includes, as items, an “item number” identifying each piece of information included in the usage fee information 132 and a “usage fee,” in which the usage fee of the virtual machine 3 per unit time (for example, one hour) is set.

For example, in the usage fee information 132 illustrated in FIG. 24, information having “1” as an “item number” has “10 (yen/hour)” set therein as a “usage fee.”

Returning to FIG. 12, when the information receiving unit 113 receives the usage schedule information 133 (YES in S11), for example, the information obtaining unit 114 further obtains a weighting value included in the weighting information 134 from the information storage region 130 (S104). A concrete example of the weighting information 134 will be described in the following.

Concrete Example of Weighting Information

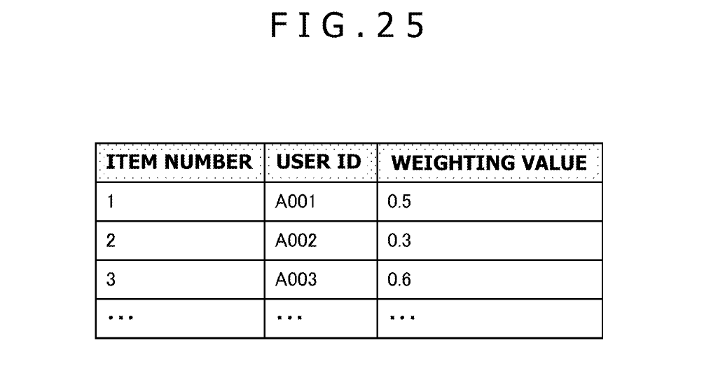

FIG. 25 is a diagram of assistance in explaining a concrete example of the weighting information 134. The weighting information 134 is information including a weighting value by which the usage scheduled time and the usage actual result time are each multiplied when the predicted value of the cumulative usage fee is calculated. The cloud operator, for example, may store the weighting information 134 in the information storage region 130 in advance.

The weighting information 134 illustrated in FIG. 25 includes, as items, an “item number” identifying each piece of information included in the weighting information 134, a “user ID” identifying a cloud user making an application for using a virtual machine 3, and a “weighting value” in which a weighting value corresponding to each cloud user is set. Incidentally, a value of zero to one both inclusive, for example, is set as the “weighting value.” In addition, the following description will be made supposing that a weighting value by which to multiply the usage scheduled time is set as the “weighting value.”

For example, in the weighting information 134 illustrated in FIG. 25, information having “1” as an “item number” has “A001” set therein as a “user ID,” and has “0.5” set therein as a “weighting value.” Description of other information included in FIG. 25 will be omitted.

For example, the cloud operator determines the weighting information 134 different for each cloud user. The cloud operator, for example, makes the determination such that the weighting value (weighting value by which to multiply the usage scheduled time) of a cloud user having a large deviation between the usage scheduled time of the virtual machine 3 for which an application has been made in the past and the usage actual result time of the virtual machine 3 actually used is smaller than the weighting value of another cloud user having a small deviation. The information processing device 1 may thereby predict the cumulative usage fee according to past usage conditions of each cloud user.

Returning to FIG. 12, the fee predicting unit 115 of the information processing device 1 calculates a first value by dividing, by the first period, a value obtained by multiplying the usage scheduled time obtained in the processing of S101 by the usage fee per unit time which usage fee is obtained in the processing of S103 (S105). For example, the fee predicting unit 115 calculates the first value, which is a usage fee per unit period (for example, one day) which usage fee occurs when use of the virtual machine 3 is made according to the usage scheduled time for which an application is made.

For example, information having “1” as an “item number” in the usage schedule information 133 illustrated in FIG. 23 has “200 (hours)” set therein as a “usage scheduled time,” and has “40 (days)” set therein as a “usage scheduled period.” In addition, information having “1” as an “item number” in the usage fee information 132 illustrated in FIG. 24 has “10 (yen/hour)” set therein as a “usage fee.” Therefore, in this case, the fee predicting unit 115 calculates “50 (yen/day)” as the first value, which results from dividing a value obtained by multiplying “200 (hours)” and “10 (yen/hour)” together by “40 (days).”

Then, the fee predicting unit 115 calculates a second value by dividing, by a second period as a past period, a value obtained by multiplying a usage actual result time of use of the virtual machine 3 in the second period, which usage actual result time is included in the usage actual result time obtained in the processing of S102, by the usage fee per unit time which usage fee is obtained in the processing of S103 (S106). For example, the fee predicting unit 115 calculates the second value as a usage fee per unit period (for example, one day) which usage fee actually occurs with the past use of the virtual machine 3. Incidentally, the second period may, for example, be a most recent period (for example, a period including a time point at which the processing of S11 is performed) in a period for which the usage actual result time is obtained.

For example, information having “16” as an “item number” in the usage actual result information 131 illustrated in FIG. 22 has “2016/12/12” set therein as a “date,” and has “180 (hours)” set therein as a “usage actual result time.” In addition, information having “9” as an “item number” in the usage actual result information 131 illustrated in FIG. 22 has “2016/12/5” set therein as a “date,” and has “110 (hours)” set therein as a “usage actual result time.” For example, the usage actual result information 131 illustrated in FIG. 22 indicates that the usage actual result time of the virtual machine 3 in a period of seven days (most recent period of seven days) from Dec. 5, 2016 to December 12 is “70 (hours).”

In addition, information having “1” as an “item number” in the usage fee information 132 illustrated in FIG. 24 has “10 (yen/hour)” set therein as a “usage fee.” Therefore, in this case, the fee predicting unit 115, for example, calculates “100 (yen/day)” as the second value by dividing a value obtained by multiplying “70 (hours)” and “10 (yen/hour)” together by “7 (days).”

Thereafter, as illustrated in FIG. 13, the fee predicting unit 115 calculates a value obtained by adding a value obtained by multiplying the weighting value obtained in the processing of S104 by the first value calculated in the processing of S105 to a value obtained by multiplying a value obtained by subtracting the value represented by the weighting value obtained in the processing of S104 from one by the second value calculated in the processing of S106 (S111).

For example, information having “1” as an “item number” in the weighting information 134 illustrated in FIG. 25 has “0.5” set therein as a “weighting value.” Therefore, the fee predicting unit 115 calculates “25 (yen/day)” by multiplying “0.5” by “50 (yen/day)” calculated as the first value. In addition, the fee predicting unit 115 calculates “50 (yen/day)” by multiplying “0.5,” which is a value obtained by subtracting “0.5” from “1,” by “100 (yen/day)” calculated as the second value. The fee predicting unit 115 then calculates “75 (yen/day)” by adding the calculated values of “25 (yen/day)” and “50 (yen/day)” together.

Next, the fee predicting unit 115 calculates a cumulative usage fee at a time point of an end of the second period by multiplying a usage actual result time up to the time point of the end of the second period, which usage actual result time is included in the usage actual result time obtained in the processing of S102, by the usage fee per unit time which usage fee is obtained in the processing of S103 (S112). The fee predicting unit 115 then generates a linear straight line having the value calculated in the processing of S111 as a slope, and passing through a specific point whose X-coordinate corresponds to the time point of the end of the second period and whose Y-coordinate corresponds to the cumulative usage fee calculated in the processing of S112 (S113). For example, the fee predicting unit 115 generates the following Equation (1).

γ=α(t−t₀)+γ₀ (1)

In Equation (1), t is a variable representing a unit period (date) included in a period of use of the virtual machine 3, γ is a variable representing the cumulative usage fee of the virtual machine 3 up to the unit period represented by t. In addition, α is a constant representing the value calculated in the processing of S111, t₀ is a constant representing the time point of the end of the second period (unit period including the time point of the end), and γ₀ is a constant representing the cumulative usage fee up to the unit period including the time point of the end of the second period.

Incidentally, a date of Nov. 27, 2016 and subsequent dates are set as the “date” in the usage actual result information 131 illustrated in FIG. 22. Therefore, the following description will be made supposing that X-coordinates in a coordinate plane correspond to the number of days elapsed since Nov. 27, 2016. In addition, the following description will be made supposing that the second period is a period from Nov. 27, 2016 to Dec. 12, 2016.

For example, latest information in the usage actual result information 131 illustrated in FIG. 22 is information having “2016/12/12” set therein as a “date” (information having “16” as an “item number”). Dec. 12, 2016 is a date on which 16 (days) has elapsed since Nov. 27, 2016. In addition, the information having “16” as an “item number” in the usage actual result information 131 illustrated in FIG. 22 has “180 (hours)” set therein as a “usage actual result time.” Further, information having “1” as an “item number” in the usage fee information 132 illustrated in FIG. 24 has “10 (yen/hour)” set therein as a “usage fee.”

Therefore, in this case, the fee predicting unit 115 calculates “1800 (yen),” which is a value obtained by multiplying “180 (hours)” and “10 (yen/hour)” together, as the predicted value of the cumulative usage fee at the time point of the end of the second period (S112).

The fee predicting unit 115 thereafter generates the following Equation (2) by substituting “75,” which is the value calculated in the processing of S111, into α, substituting “1800” into γ₀, and substituting “16” into t₀ in Equation (1).

γ=75t+600 (2)

Thus, the fee predicting unit 115 may calculate the predicted value of the cumulative usage fee by substituting the unit period (date) for which a cumulative usage time of the virtual machine 3 is predicted into t in Equation (2).

For example, “40 (days)” is set as the “usage scheduled period” of the usage schedule information 133 illustrated in FIG. 23. Therefore, by substituting “56,” which is obtained by adding “16” representing Dec. 12, 2016 to “40,” for example, into tin Equation (2), the fee predicting unit 115 calculates “4800 (yen)” as the predicted value of the cumulative usage fee at a time point of an end of a period (first period) for which a usage application is made by the cloud user.

Returning to FIG. 10, the information output unit 116 of the information processing device 1 thereafter outputs the predicted value of the cumulative usage fee which predicted value is calculated in the processing of S12 to the user terminal 11 (S13).

The information output unit 116 thereafter waits until receiving an application for using the virtual machine 3 from the cloud user (NO in S14). For example, the information output unit 116 waits until the cloud user viewing the predicted value of the cumulative usage fee which predicted value is output to the user terminal 11 makes an application for using the virtual machine 3 based on contents included in the information received in the processing of S11.

When an application for using the virtual machine 3 is then received (YES in S14), the output determining unit 117 of the information processing device 1 determines whether or not the predicted value of the cumulative usage fee which predicted value is calculated in the processing of S12 exceeds the upper limit value (S15).

When a result of the determination indicates that the predicted value of the cumulative usage fee which predicted value is calculated in the processing of S12 exceeds the upper limit value (YES in S15), the information output unit 116 outputs information indicating that the usage application received in the processing of S14 is rejected (S16).

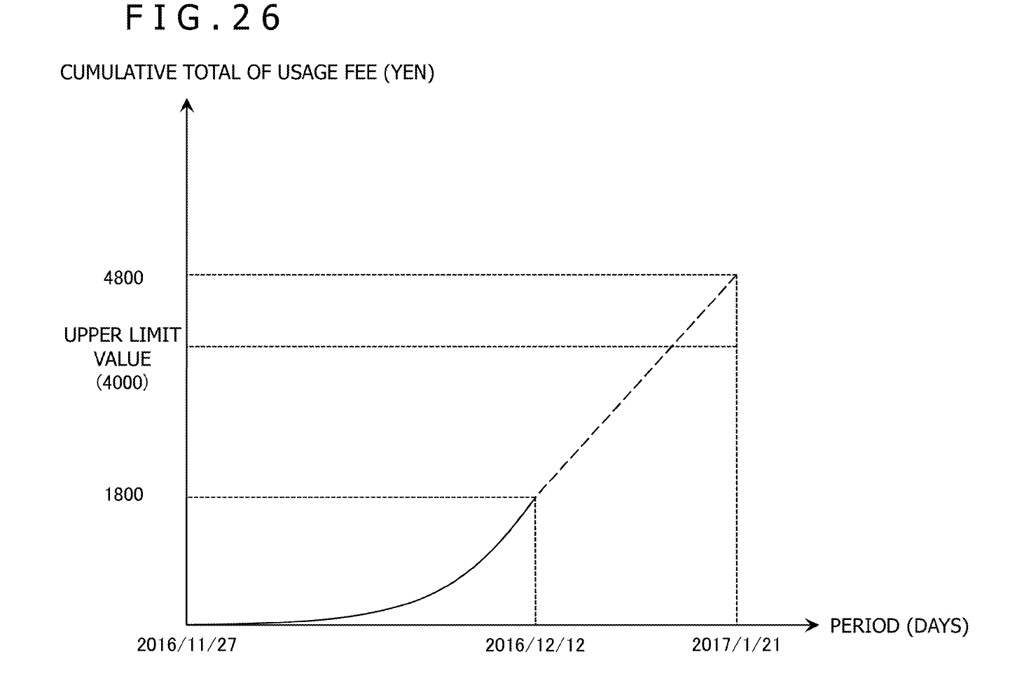

For example, as illustrated in FIG. 26, when the upper limit value information 135 stored in the information storage region 130 indicates “4000 (yen)” whereas the predicted value of the cumulative usage fee which predicted value is calculated in the processing of S12 is “4800 (yen),” the information output unit 116 outputs information indicating that the usage application is rejected.

For example, when the predicted value of the cumulative usage fee exceeds the upper limit value, the information output unit 116 determines that there is a possibility that the cumulative usage fee of the virtual machine 3 used by the cloud user may exceed the upper limit value determined by the cloud user in advance. Therefore, in this case, the information output unit 116 outputs information to the effect that the usage application received in the processing of S14 is rejected.

When the predicted value of the cumulative usage fee which predicted value is calculated in the processing of S12 does not exceed the upper limit value (NO in S15), on the other hand, the information output unit 116, for example, outputs the predicted value of the cumulative usage fee which predicted value is calculated in the processing of S12 to an approver terminal (not illustrated), as illustrated in FIG. 11 (S21).

For example, when an approver makes final determination as to whether or not to approve the usage application received in the processing of S14, the information output unit 116 outputs the predicted value of the cumulative usage fee which predicted value is calculated in the processing of S12 to the approver terminal, and waits until the approver gives a final approval.

When information indicating approval of the usage application received in the processing of S14 is then received from the approver terminal (YES in S22), the information output unit 116 outputs information indicating approval of the usage application received in the processing of S14 (S24).

In addition, in this case, the information output unit 116 stores the usage schedule information 133 received in the processing of S11 in the information storage region 130 (S25). For example, as illustrated in an underlined part in FIG. 27, the information output unit 116 stores the usage schedule information 133 received in the processing of S11 (information having “18” as an “item number”) in the information storage region 130.

Further, in this case, the information output unit 116, for example, instructs a managing device (not illustrated) managing the virtual machine 3 to dispose the virtual machine 3 corresponding to the contents of the usage schedule information 133 received in the processing of S11 (S26).

When information indicating rejection of the usage application received in the processing of S14 is received from the approver terminal (NO in S22), on the other hand, the information output unit 116 outputs information indicating rejection of the usage application received in the processing of S14 (S23).

Usage Fee Prediction Processing (2)

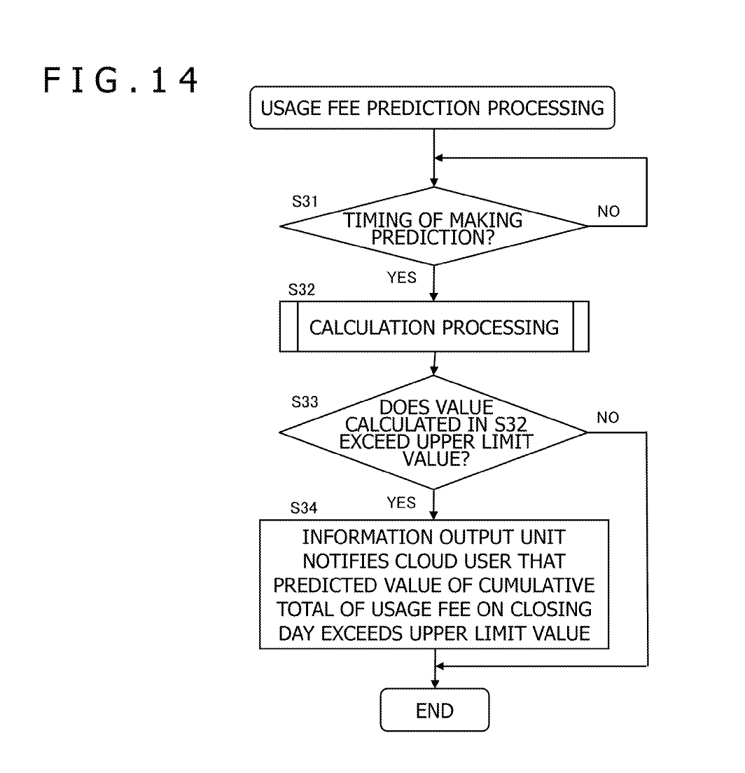

Description will next be made of usage fee prediction processing spontaneously performed by the information processing device 1. FIG. 14 is a diagram of assistance in explaining the usage fee prediction processing spontaneously performed by the information processing device 1.

The information obtaining unit 114 waits until timing of making prediction (NO in S31). The timing of making prediction may be, for example, timing determined in advance, such as 12 o'clock each day.

When the timing of making prediction then arrives (YES in S31), the information obtaining unit 114 and the like perform calculation processing (S32). The calculation processing will be described in the following.

Calculation Processing (2)

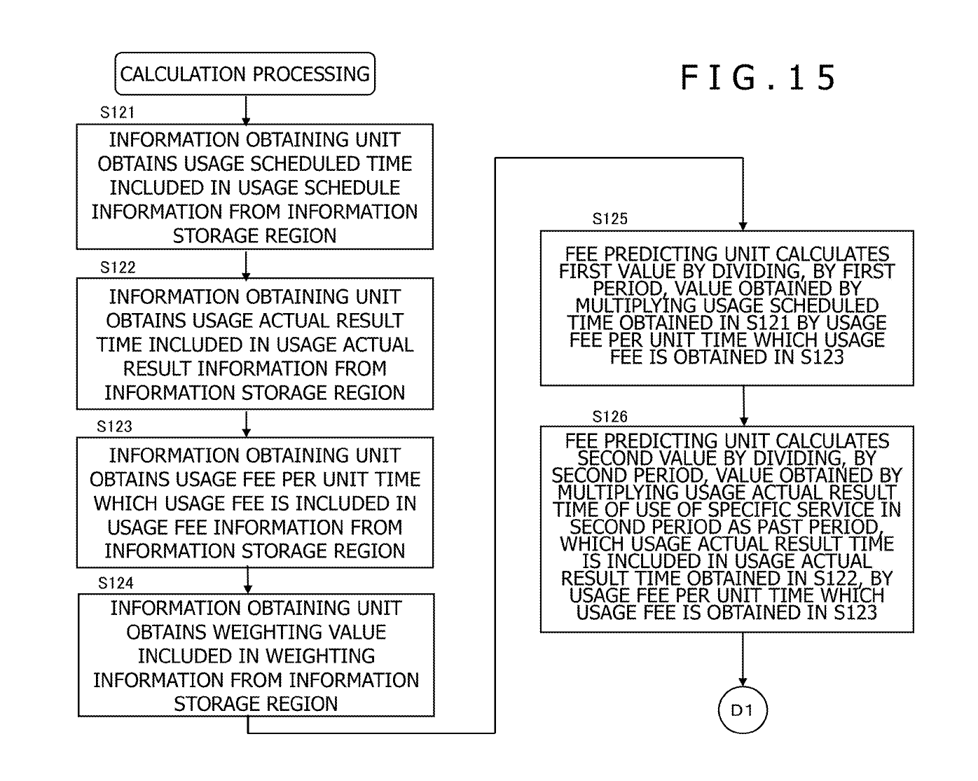

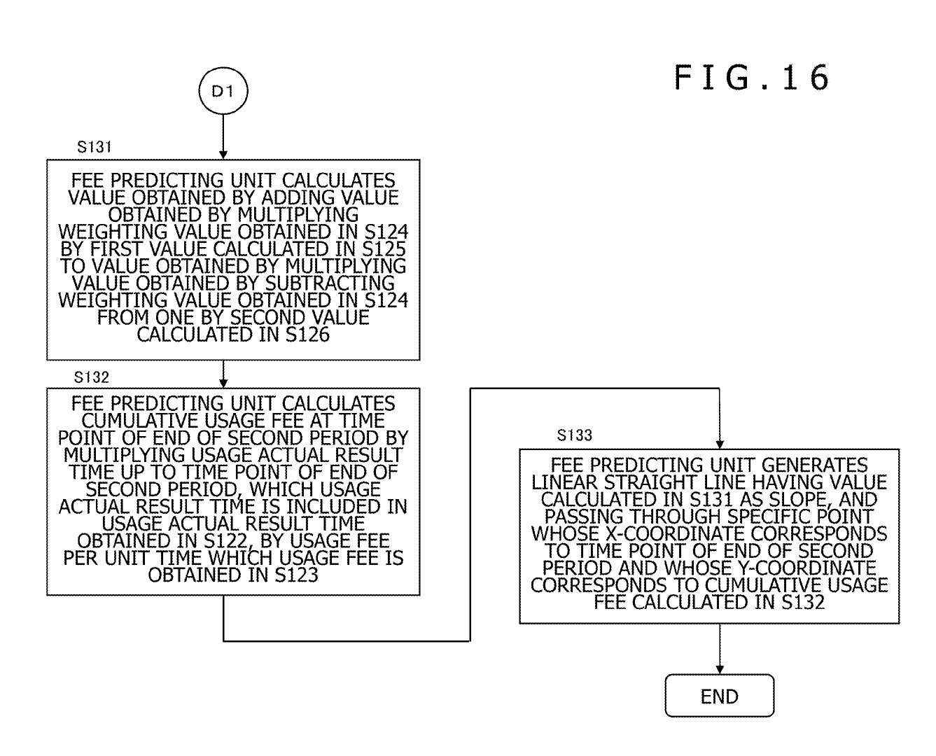

FIG. 15 and FIG. 16 are diagrams of assistance in explaining the calculation processing. For example, FIG. 15 and FIG. 16 are diagrams of assistance in explaining the calculation processing performed when the timing of making prediction arrives, for example.

As illustrated in FIG. 15, when the timing of making prediction arrives (YES in S31), for example, the information obtaining unit 114 obtains the usage scheduled time included in the usage schedule information 133 and the usage actual result time included in the usage actual result information 131 from the information storage region 130 (S121 and S122). In addition, in this case, the information obtaining unit 114 obtains the usage fee per unit time which usage fee is included in the usage fee information 132 and the weighting value included in the weighting information 134 from the information storage region 130 (S123 and S124).

Then, as in the case described with reference to FIG. 12, the fee predicting unit 115 calculates a first value by dividing, by the first period, a value obtained by multiplying the usage scheduled time obtained in the processing of S121 by the usage fee per unit time which usage fee is obtained in the processing of S123 (S125). In addition, the fee predicting unit 115 calculates a second value by dividing, by the second period as a past period, a value obtained by multiplying a usage actual result time of use of the virtual machine 3 in the second period, which usage actual result time is included in the usage actual result time obtained in the processing of S122, by the usage fee per unit time which usage fee is obtained in the processing of S123 (S126).

Thereafter, as illustrated in FIG. 16, as in the case described with reference to FIG. 13, the fee predicting unit 115 calculates a value obtained by adding a value obtained by multiplying the weighting value obtained in the processing of S124 by the first value calculated in the processing of S125 to a value obtained by multiplying a value obtained by subtracting the weighting value obtained in the processing of S124 from one by the second value calculated in the processing of S126 (S131).

Next, as in the case described with reference to FIG. 13, the fee predicting unit 115 calculates a cumulative usage fee at a time point of an end of the second period by multiplying a usage actual result time up to the time point of the end of the second period, which usage actual result time is included in the usage actual result time obtained in the processing of S122, by the usage fee per unit time which usage fee is obtained in the processing of S123 (S132). Then, as in the case described with reference to FIG. 13, the fee predicting unit 115 generates a linear straight line having the value calculated in the processing of S131 as a slope, and passing through a specific point whose X-coordinate corresponds to the time point of the end of the second period and whose Y-coordinate corresponds to the cumulative usage fee calculated in the processing of S132 (S133).

Returning to FIG. 14, the information output unit 116 determines whether or not the predicted value of the cumulative usage fee which predicted value is calculated in the processing of S32 exceeds the upper limit value (S33).

When a result of the determination indicates that the predicted value of the cumulative usage fee which predicted value is calculated in the processing of S32 exceeds the upper limit value (YES in S33), the information output unit 116 notifies the cloud user that the predicted value of the cumulative total of the usage fee on the closing day exceeds the upper limit value (S34).

For example, the fee predicting unit 115 calculates the predicted value of the cumulative usage fee spontaneously even when the usage schedule information 133 is not received from the cloud user. Then, when a current pace of use of the virtual machine 3 by the cloud user is a pace at which the upper limit value is exceeded on the closing day, the information output unit 116 notifies the cloud user to that effect.

The information output unit 116 may thereby prompt the cloud user to review the pace of use of the virtual machine 3.

Usage Fee Prediction Processing (3)

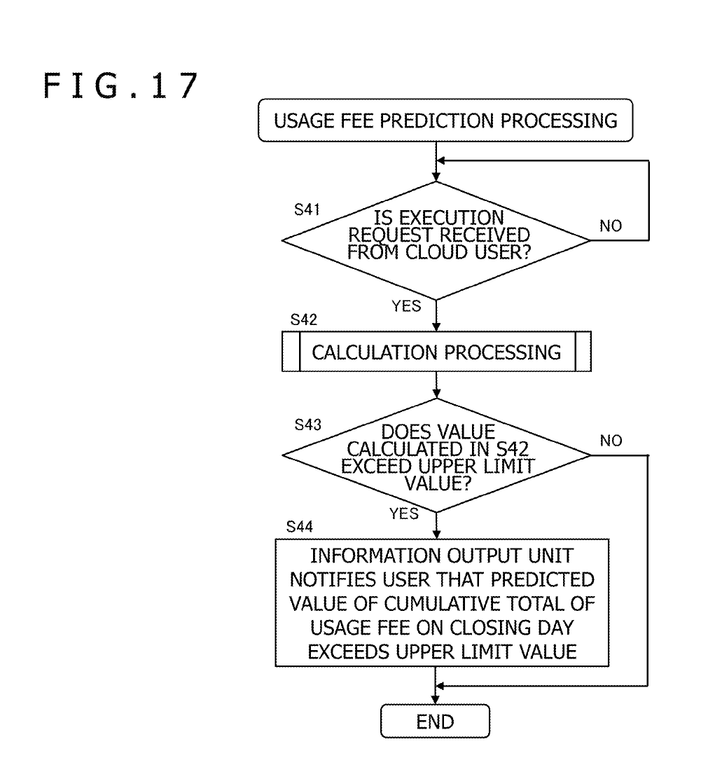

Description will next be made of usage fee prediction processing performed when a request to perform the usage fee prediction processing is received from the cloud user. FIG. 17 is a diagram of assistance in explaining the usage fee prediction processing performed when a request to perform the usage fee prediction processing is received from the cloud user.

The information obtaining unit 114 waits until receiving a request to perform the usage fee prediction processing from the cloud user (NO in S41). For example, the information obtaining unit 114 waits until the cloud user transmits a request to perform the usage fee prediction processing (request without an application for using the virtual machine) via the user terminal.

When a request to perform the usage fee prediction processing is then received (YES in S41), the information obtaining unit 114 and the like perform calculation processing (S42). For example, the information obtaining unit 114 performs the calculation processing described with reference to FIG. 15 and FIG. 16.

The information output unit 116 thereafter determines whether or not the predicted value of the cumulative usage fee which predicted value is calculated in the processing of S42 exceeds the upper limit value (S43).

When a result of the determination indicates that the predicted value of the cumulative usage fee which predicted value is calculated in the processing of S42 exceeds the upper limit value (YES in S43), the information output unit 116 notifies the cloud user that the predicted value of the cumulative total of the usage fee on the closing day exceeds the upper limit value (S44).

For example, when the usage fee prediction processing performed in response to the performance request from the cloud user indicates that a current pace of use of the virtual machine 3 by the cloud user is a pace at which the upper limit value is exceeded on the closing day, the fee predicting unit 115 notifies the cloud user to that effect.

The information output unit 116 may thereby increase opportunities of prompting the cloud user to review the pace of use of the virtual machine 3.

Usage Fee Prediction Processing (4)

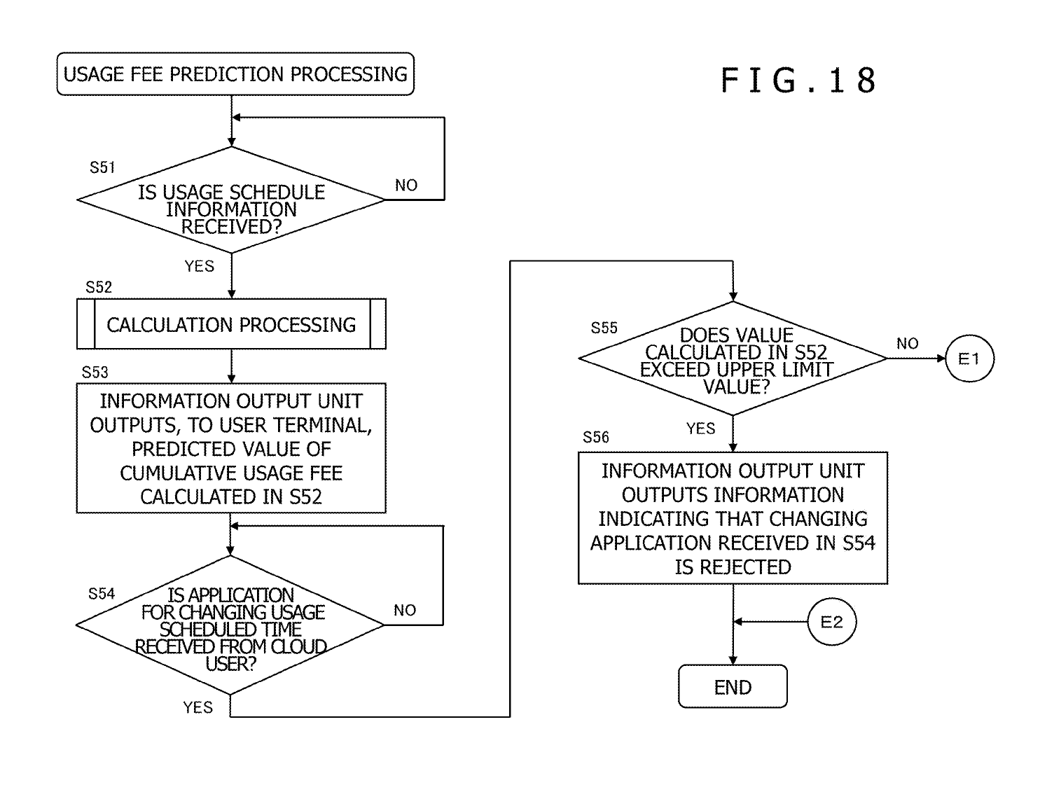

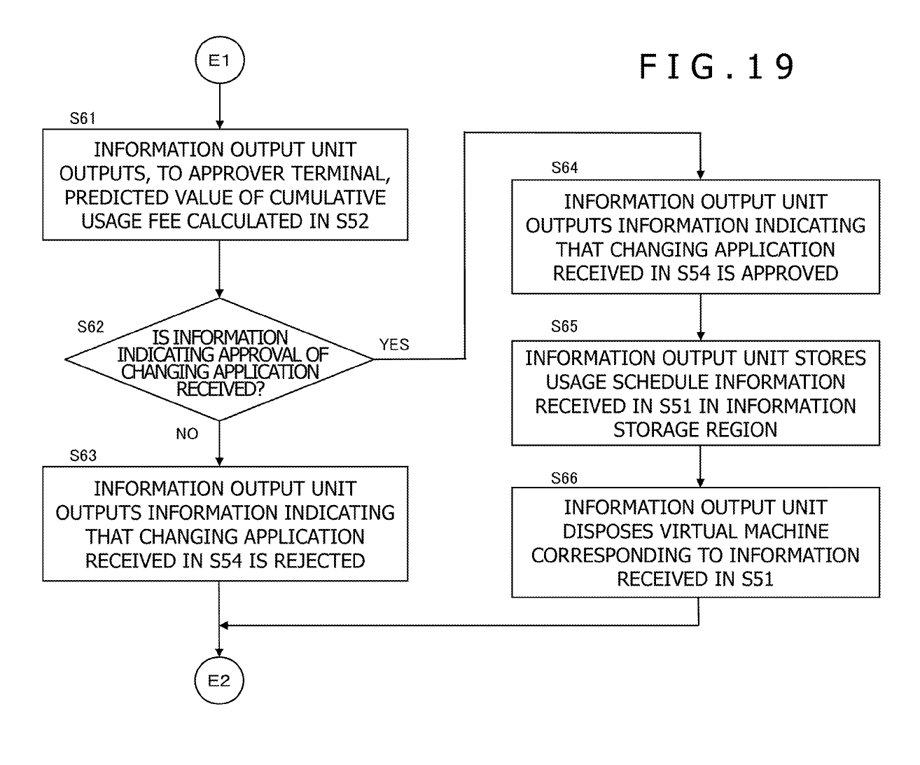

Description will next be made of usage fee prediction processing performed when an application for changing the usage scheduled time of the virtual machine 3 is received in a case where the cloud user is already using the virtual machine 3. FIG. 18 and FIG. 19 are diagrams of assistance in explaining the usage fee prediction processing performed when an application for changing the usage scheduled time of the virtual machine 3 is received.

As illustrated in FIG. 18, the information receiving unit 113 waits until receiving the usage schedule information 133 transmitted by the cloud user via the user terminal 11 (NO in S51).

When the information receiving unit 113 then receives the usage schedule information 133 (YES in S51), the information obtaining unit 114 and the like perform calculation processing (S52). For example, the information obtaining unit 114 performs the calculation processing described with reference to FIG. 12 and FIG. 13.

The information output unit 116 next outputs the predicted value of the cumulative usage fee which predicted value is calculated in the processing of S52 to the user terminal 11 (S53).

The information output unit 116 thereafter waits until receiving an application for changing the usage scheduled time from the cloud user (NO in S54). For example, the information output unit 116 waits until the cloud user viewing the predicted value of the cumulative usage fee which predicted value is output to the user terminal 11 makes an application for changing the usage scheduled time based on contents included in the information received in the processing of S51.

Then, when receiving an application for changing the usage scheduled time (YES in S54), the information output unit 116 determines whether or not the predicted value of the cumulative usage fee which predicted value is calculated in the processing of S52 exceeds the upper limit value (S55).

When a result of the determination indicates that the predicted value of the cumulative usage fee which predicted value is calculated in the processing of S52 exceeds the upper limit value (YES in S55), the information output unit 116 outputs information indicating that the changing application received in the processing of S54 is rejected (S56).

For example, when the predicted value of the cumulative usage fee exceeds the upper limit value, the information output unit 116 determines that there is a possibility that the usage fee of the virtual machine 3 after a change by the cloud user may exceed the upper limit value determined by the cloud user in advance. Therefore, in this case, the information output unit 116 outputs information to the effect that the changing application received in the processing of S54 is rejected.

When the predicted value of the cumulative usage fee which predicted value is calculated in the processing of S52 does not exceed the upper limit value (NO in S55), on the other hand, the information output unit 116 outputs the value calculated in the processing of S52 as the predicted value of the cumulative usage fee to an approver terminal (not illustrated) (S61), as illustrated in FIG. 19, for example.

For example, when an approver makes final determination as to whether or not to approve the changing application received in the processing of S54, the information output unit 116 outputs the value calculated in the processing of S52 as the predicted value of the cumulative usage fee to an approver terminal, and waits until the approver gives a final approval.

When information indicating approval of the changing application received in the processing of S54 is then received from the approver terminal (YES in S62), the information output unit 116 outputs information indicating approval of the changing application received in the processing of S54 (S64). In addition, in this case, the information output unit 116 stores the usage schedule information 133 received in the processing of S51 in the information storage region 130 (S65). Further, in this case, the information output unit 116 disposes the virtual machine 3 corresponding to the contents of the usage schedule information 133 received in the processing of S51 (S66).

When information indicating rejection of the changing application received in the processing of S54 is received from the approver terminal (NO in S62), on the other hand, the information output unit 116 outputs information indicating rejection of the changing application received in the processing of S54 (S63).

For example, as described with reference to FIG. 10 and the like, the information processing device 1 calculates the predicted value of the cumulative usage fee of the virtual machine 3 in the future, and presents the predicted value to the cloud user. Therefore, the cloud user may refer to the presented predicted value, and examine whether or not the contents of the approved usage application are appropriate.

When the information processing device 1 then receives the usage schedule information 133 again after the approval of the application for using the virtual machine 3, the information processing device 1 outputs the predicted value of the cumulative usage fee according to the contents of the received usage schedule information 133 as in the case where the application for using the virtual machine 3 is received.

The cloud user may thereby determine whether or not to change the contents of the already approved application for using the virtual machine 3.

Weighting Update Processing

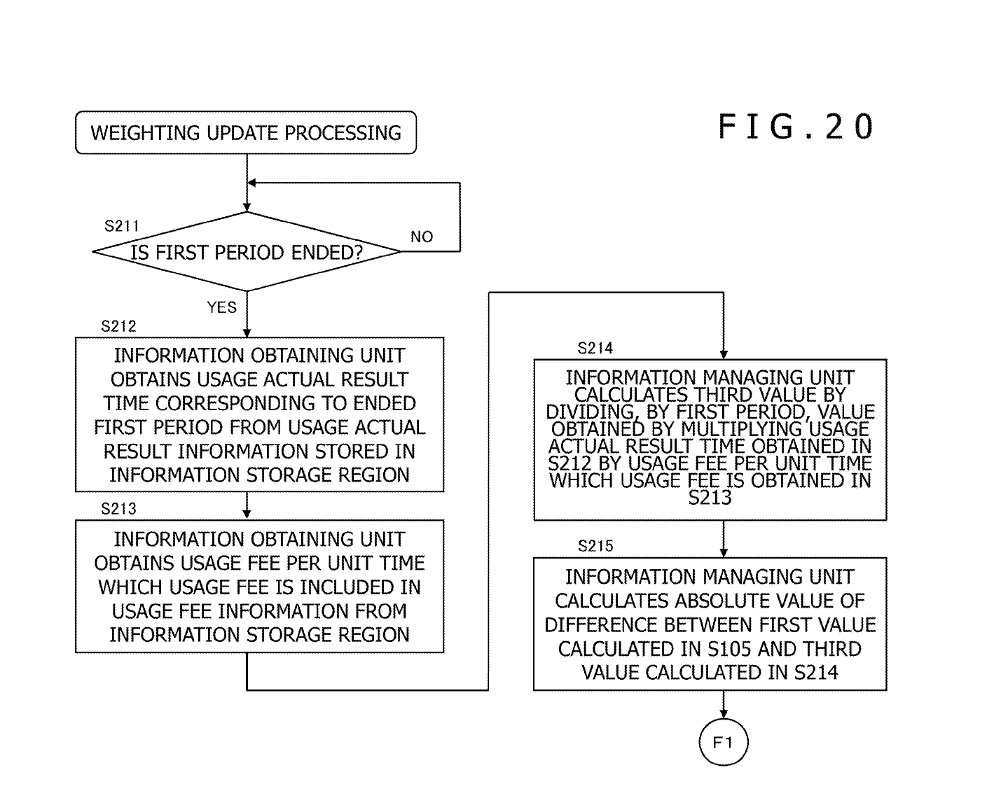

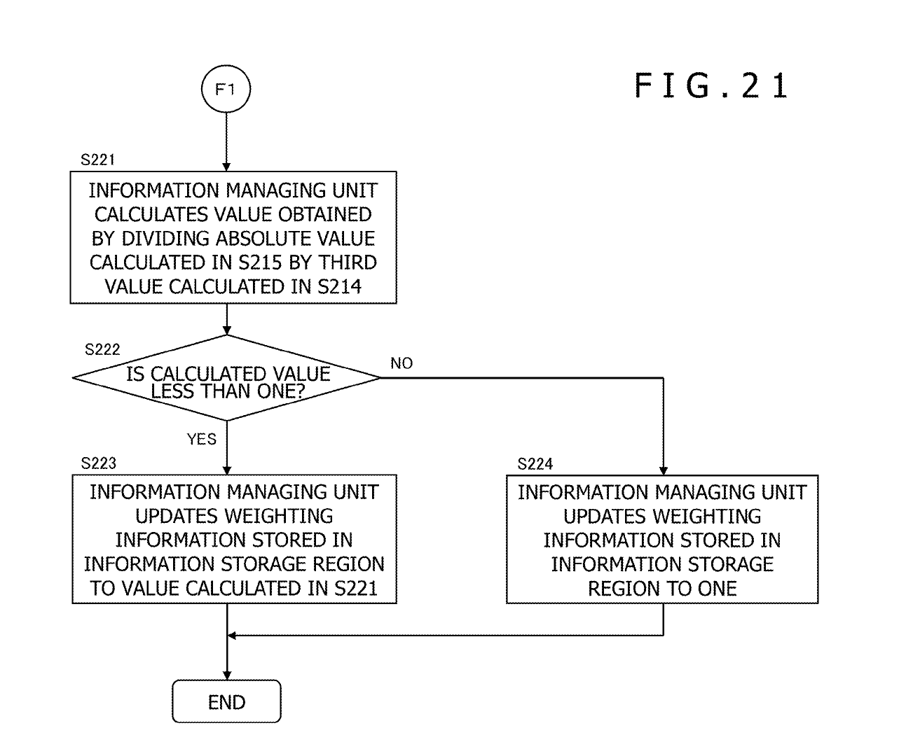

Description will next be made of processing of updating the weighting information 134 (which processing will hereinafter be referred to also as weighting update processing). FIG. 20 and FIG. 21 are diagrams of assistance in explaining the weighting update processing.

The information obtaining unit 114 waits until the first period is ended (NO in S211). For example, the information obtaining unit 114 waits until arrival of one of dates set as the “usage time limit” of the usage schedule information 133 illustrated in FIG. 27.

When the first period is then ended (YES in S211), the information obtaining unit 114 obtains a usage actual result time corresponding to the ended first period from the usage actual result information 131 stored in the information storage region 130 (S212). In addition, in this case, the information obtaining unit 114 obtains the usage fee per unit time which usage fee is included in the usage fee information 132 from the information storage region 130 (S213).

Next, the information managing unit 112 calculates a third value by dividing, by the first period, a value obtained by multiplying the usage actual result time obtained in the processing of S212 by the usage fee per unit time which usage fee is obtained in the processing of S213 (S214). For example, the information managing unit 112 calculates the third value, which is a usage fee per unit period (for example, one day) which usage fee actually occurs with the use of the virtual machine 3 in the first period.

Further, the information managing unit 112 calculates the absolute value of a difference between the first value calculated in the processing of S105 and the third value calculated in the processing of S214 (S215).

Thereafter, as illustrated in FIG. 21, the information managing unit 112 calculates a value obtained by dividing the absolute value calculated in the processing of S215 by the third value calculated in the processing of S214 (S221).

Then, when the value calculated in the processing of S221 is less than one (YES in S222), the information managing unit 112 updates the weighting information 134 stored in the information storage region 130 to the value calculated in the processing of S221 (S223). When the value calculated in the processing of S221 is one or more (NO in S222), on the other hand, the information managing unit 112 updates the weighting information 134 stored in the information storage region 130 to one (S224).

The information processing device 1 may thereby update the weighting information 134 stored in the information storage region 130 as needed. Therefore, the information processing device 1 may properly predict the cumulative usage fee according to the past usage conditions of each cloud user.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A data center comprising:
a server hosting a plurality of virtual machines; and
an information processing device configured to
receive from a user terminal device, communicatively connected to the data center, a usage request for the use of a service executed by one of the plurality of virtual servers for a finite period of time, the finite period of time occurring within a first time period,
obtain from a memory, in response to the usage request, data indicating previous usage duration time of the service by the user terminal device and a usage fee per unit time associated with the previous usage duration time,
calculate a cumulative usage fee for the usage request based on the finite period of time included in the usage request, the previous usage duration time of the service by the user terminal device, and the usage fee per unit time associated with the previous usage duration time, and
output the predicted cumulative usage fee.

2. The data center according to claim 1,
wherein the calculate includes
generating a linear straight line in a coordinate plane having an X-axis corresponding to a period of use of the service and having a Y-axis corresponding to the cumulative usage fee, and
calculating a cumulative usage fee indicated by a Y-coordinate of a point on the linear straight line, the point having an X-coordinate corresponding to a time point representing the end of the finite period of time, as the cumulative usage fee occurring up to the time point with the use of the service.

3. The data center according to claim 2,
wherein the generating includes
calculating a first value by dividing, by the first time period, a value obtained by multiplying the finite period of time by the usage fee per unit time,
calculating a second value by dividing, by a second time period, a value obtained by multiplying the previous usage duration time of the service by the user terminal device in the second time period by the usage fee per unit time, and
generating the linear straight line having, as a slope, a value calculated based on the calculated first value and the calculated second value, and passing through a specific point having an X-coordinate corresponding to a time point of an end of the second time period and having a Y-coordinate corresponding to a cumulative usage fee calculated by multiplying the previous usage duration time of the service by the user terminal device up to a time point representing the end of the second time period by the usage fee per unit time.

4. The data center according to claim 3, wherein
the generating of the linear straight line passing through the specific point sets, as the slope, a value obtained by adding a value obtained by multiplying a weighting value as a value of zero to one both inclusive by the first value to a value obtained by multiplying a value obtained by subtracting the weighting value from one by the second value.

5. The data center according to claim 3, wherein
the second time period is a period including a time point at which the usage request is received.

6. The data center according to claim 1, wherein
the received usage request is further stored in the memory.

7. The data center according to claim 4, for making the computer further perform:
calculating a third value by dividing, by the first time period, a value obtained by multiplying the previous usage duration time of the service by the user terminal device in the first time period by the usage fee per unit time after passage of the first time period; and
updating the weighting value to a value obtained by dividing an absolute value of a difference between the first value and the third value by the third value when the value obtained by dividing the absolute value of the difference between the first value and the third value by the third value is a value less than one, and updating the weighting value to one when the value obtained by dividing the absolute value of the difference between the first value and the third value by the third value is a value of one or more.

8. An information processing device communicatively connected to a server executing a plurality of virtual machines, the information processing device comprising:
a memory; and
a processor coupled to the memory and the processor configured to
receive from a user terminal device, communicatively connected to the server, a usage request for the use of a service executed by one of the plurality of virtual servers for a finite period of time, the finite period of time occurring within a first time period,
obtain from the memory, in response to the usage request, data indicating previous usage duration time of the service by the user terminal device and a usage fee per unit time associated with the previous usage duration time,
calculate a cumulative usage fee for the usage request based on the finite period of time included in the usage request, the previous usage duration time of the service by the user terminal device, and the usage fee per unit time associated with the previous usage duration time, and
output the predicted cumulative usage fee.
